(19) United States
(12) Patent Application Publication
(10) Pub. No.: US 2010/0090959 A1
(43) Pub. Date: Apr. 15, 2010

(54) FORMING A KEYBOARD FROM A COMBINATION OF KEYS DISPLAYED ON A TOUCH SENSITIVE DISPLAY AND ON A SEPARATE KEYPAD

(75) Inventor: John W. Zaremba, Raleigh, NC (US)

Correspondence Address: MYERS BIGEL SIBLEY & SAJOVEC, P.A., P.O. BOX 37428, RALEIGH, NC, 27627, US

(73) Assignee: Sony Ericsson Mobile Communications AB

(21) Appl. No.: 12/250,800

(22) Filed: Oct. 14, 2008

(51) Int. Cl. G06F 3/02

(52) U.S. Cl. 345/169

(57) ABSTRACT

An electronic device provides a keyboard that includes some keys that are displayed on a touch sensitive display, and other keys that are included within a separate keypad. A controller assigns a first group of keypad keys to a first portion of a keyboard, displays on the touch sensitive display a second group of keys that are assigned to a second portion of the keyboard, and outputs a sequence of characters corresponding to keys on the touch sensitive display and on the keypad that are touch selected by the user. Accordingly, a user may thereby type entries using a virtual keyboard that extends across the touch sensitive display and the keypad.

### FIELD OF THE INVENTION

This invention relates to user interfaces for electronic devices, and more particularly to touch sensitive display interfaces for electronic devices such as wireless communication terminals.

### BACKGROUND OF THE INVENTION

Touch sensitive displays are becoming a popular interface on electronic devices for users to enter commands and data used in the operation of the device. Touch displays can now be found in mobile telephones, particularly cellular telephones having integrated PDA (personal digital assistant) features and other phone operation related features. The touch displays are generally designed to operate and respond to a finger touch, a stylus touch, or finger/stylus movement on the touch screen surface. Some devices now display virtual keys on a touch display that are arranged to form a virtual keyboard, such as a conventional QWERTY keyboard, that includes both alphabetic keys and numeric keys.

Touching a specific point on the touch display may activate a virtual key, feature, or function found or shown at that location on the touch display. Typical phone features which may be operated by touching the touch display include entering a telephone number, for example, by touching virtual keys of a virtual keyboard shown on the display, making a call or ending a call, bringing up, adding to or editing and navigating through an address book, and other phone functions such as text messaging, wireless connection to the global computer network, and other phone functions.

Commercial pressures to provide far more functionality within smaller physical device sizes is continuing to drive the need to develop even more versatile user interfaces.

### SUMMARY OF THE INVENTION

Various embodiments of the present invention are directed to an electronic device that provides a keyboard that includes some keys that are displayed on a touch sensitive display, and other keys that are included within a separate keypad. Accordingly, a virtual keyboard may be formed that extends across the touch sensitive display and the keypad, and which may enable a user to more easily type sentences thereon.

In some embodiments, an electronic device includes a keypad, a touch sensitive display, and a controller. The keypad includes a first group of keys. The touch sensitive display is configured to display graphics and to detect user touches relative to the displayed graphics. The keypad is separate from the touch sensitive display. The controller is configured to assign the first group of keypad keys to a first portion of a keyboard, to display on the touch sensitive display a second group of keys that are assigned to a second portion of the keyboard, and to output a sequence of characters corresponding to keys on the touch sensitive display and on the keypad that are touch selected by the user.

In some further embodiments, the first group of keys are arranged in a grid along rows and columns. The controller is configured to display on the touch sensitive display the second group of keys arranged in a grid along rows and columns that are parallel to the corresponding rows and columns of the first group of keys.

In some further embodiments, the controller is configured to map user touch inputs received from the first group of keys of the keypad to correspond to input from a first portion of a QWERTY keyboard, to display the second group of keys arranged as a second portion of the QWERTY keyboard on the touch sensitive display, and to map user touch inputs on the second group of keys to correspond to typing on the second portion of the QWERTY keyboard.

The electronic device may further include an orientation sensor that is configured to detect rotation of the terminal between first and second orientations that are rotationally offset from each other. The controller may be further configured to initiate display of the second portion of the QWERTY keyboard on the touch sensitive display in response to the orientation sensor detecting that the terminal is positioned in the first orientation, and to cease display of the second portion of the QWERTY keyboard on the touch sensitive display in response to the orientation sensor detecting that the terminal is positioned in the second orientation.

The controller may be further configured to respond to the orientation sensor detecting that the terminal is positioned with a defined one of the sides facing primarily downward by initiating display of the second portion of the QWERTY keyboard on the touch sensitive display.

The controller may be further configured to respond to the orientation sensor detecting that the terminal is positioned in the first orientation by outputting alphabetic characters in response to user touch selections on keys of the keypad, and to respond to the orientation sensor detecting that the terminal is positioned in the second orientation by outputting numbers in response to user touch selections on the same keys of the keypad.

The first group of keys of the keypad may be configured to display a plurality of different alphabetic characters in a first orientation and a plurality of different numbers in a second orientation that is rotated about 90 degrees relative to the first orientation. The controller may be further configured to respond to the orientation sensor detecting that the terminal is positioned in the first orientation by displaying the second portion of the QWERTY keyboard on the touch sensitive display with alphabetic characters on the displayed second keys having the same first orientation as the alphabetic characters displayed on the keypad, and to respond to the orientation sensor detecting that the terminal is positioned in the second orientation by ceasing display of the second portion of the QWERTY keyboard on the touch sensitive display and displaying on the touch sensitive display text that has the same second orientation as the numbers on the keypad.

The controller may be further configured to respond to the orientation sensor detecting that the terminal is positioned in the first orientation by increasing and/or turning-on backlighting of an alphabetic portion of the first group of keys of the keypad while substantially not backlighting a numeric portion of the first group of keys, and to respond to the orientation sensor detecting that the terminal is positioned in the second orientation by decreasing and/or turning-off backlighting of the alphabetic portion of the first group of keys of the keypad.

The controller may be further configured to initiate display of the second portion of the QWERTY keyboard on the touch sensitive display in response to detecting at least two time-overlapping touches that have occurred on the touch sensitive display.

The controller may be further configured to change color of the second group of keys of the keyboard displayed on the touch sensitive display in response to the orientation sensor detecting movement of the terminal between the first and second orientations.

The controller may be further configured to display on the touch sensitive display the sequence of characters corresponding to the second group of displayed keyboard keys and the first group of keypad keys that are touch selected by the user, to display the sequence of characters overlapping the displayed second group of displayed keyboard keys, and to respond to the orientation sensor detecting movement of the terminal between the first and second orientations by controlling relative contrast between the second group of keyboard keys and the sequence of characters that are displayed on the touch sensitive display.

The controller may be further configured to respond to the orientation sensor detecting that the terminal is positioned in the first orientation by increasing displayed darkness of the second group of keyboard keys relative to the sequence of characters that are displayed on the touch sensitive display, and to respond to the orientation sensor detecting that the terminal is positioned in the second orientation by decreasing the displayed darkness of the second group of keyboard keys relative to the sequence of characters that are displayed on the touch sensitive display.

The controller may be further configured to display on the touch sensitive display the sequence of characters corresponding to the second group of displayed keyboard keys and the first group of keypad keys that are touch selected by the user, to display the sequence of characters overlapping the second group of keys, and to respond to the orientation sensor detecting movement of the terminal between the first and second orientations by changing color of the second group of keyboard keys and the displayed sequence of characters.

The controller may be further configured to display on the touch sensitive the sequence of characters corresponding to the second group of displayed keyboard keys and the first group of keypad keys that are touch selected by the user, to display the sequence of characters overlapping the second group of keys, to increase darkness of the second group of keyboard keys relative to the sequence of characters that are displayed on the touch sensitive display in response to a user touch selection of one of the displayed second group of keyboard keys, and to decrease of the second group of keyboard keys relative to the sequence of characters that are displayed on the touch sensitive display in response to expiration of a threshold time since a last user touch selection of one of the displayed second group of keyboard keys.

The terminal may further include a user proximity sensor, which includes a light source and a light detector, and that is configured to respond to the light detector detecting at least a threshold amount of reflected light from the light source by generate a user proximity signal that indicates that a user manipulated object has become proximately located to the touch sensitive display. The controller may be further configured to display on the touch sensitive the sequence of characters corresponding to the second group of displayed keyboard keys and the first group of keypad keys that are touch selected by the user, to display the sequence of characters overlapping the second group of keys, to control darkness of the second group of keyboard keys relative to the sequence of characters that are displayed on the touch sensitive display in response to the user proximity signal.

The controller may be further configured to display in a first portion of the touch sensitive display the sequence of characters corresponding to the second group of displayed keyboard keys and the first group of keypad keys that are touch selected by the user, to display the second group of keyboard keys in a second portion of the touch sensitive display that is adjacent to the first portion of the display, to increase the size of the second portion of the display that is used to display the second group of keyboard keys and to decrease the size of the first portion of the display in response to a user touch selection of one of the displayed second group of keyboard keys, and to decrease the size of the second portion of the display that is used to display the second group of keyboard keys and to increase the size of the first portion of the display in response to expiration of a threshold time since a last user touch selection of one of the displayed second group of keyboard keys.

The controller may be further configured to respond to the user proximity signal by increasing the size of the second portion of the display that is used to display the second group of keyboard keys and by decreasing the size of the first portion of the display, and to respond to absence of the user proximity signal during at least a threshold elapsed time by decreasing the size of the second portion of the display that is used to display the second group of keyboard keys and by increasing the size of the first portion of the display.

The controller may be further configured to respond to detection of an object that is touching the second portion of the display and moving outward therefrom by increasing the size of the displayed second group of keyboard keys.

The keypad may be configured so that ten of the first group of keys show ten different numbers in a first orientation and also show ten different alphabetic characters in a second orientation that is rotated about 90 degrees relative to the first orientation.

In some other embodiments, a method includes electronically assigning a first group of keys of a keypad to a first portion of a keyboard. A second group of keys that are assigned to a second portion of the keyboard are displayed on the touch sensitive display. Data is electronically generated to represent a sequence of characters corresponding to keys on the touch sensitive display and keys on a keypad that are touch selected by the user. The generated sequence of characters are displayed on the touch sensitive display.

Other electronic devices, methods, and/or computer program products according to embodiments of the invention will be or become apparent to one with skill in the art upon review of the following drawings and detailed description. It is intended that all such additional electronic devices, methods, and/or computer program products be included within this description, be within the scope of the present invention, and be protected by the accompanying claims.

### BRIEF DESCRIPTION OF THE DRAWINGS

The accompanying drawings, which are included to provide a further understanding of the invention and are incorporated in and constitute a part of this application, illustrate certain embodiments of the invention. In the drawings:

FIG. 1 is a front view of a wireless communication terminal that is configured to receive user input from one portion of a keyboard that is displayed on a touch sensitive display and from another portion of the keyboard that is formed on a numeric keypad in accordance with some embodiments;

FIG. 2 is another front view of the wireless communication terminal shown in FIG. 1 that has been slide open to show the keypad which includes keys having numbers arranged in a first orientation and alphabetic characters arranged in a second orientation that is rotated about 90 degrees relative to the first orientation in accordance with some embodiments;

FIG. 3 is another front view of the wireless communication terminal shown in FIG. 2 which has now been rotated onto its side to trigger a portion of the keyboard to be displayed on the touch sensitive display and to trigger backlighting of the alphabetic characters on the keypad in accordance with some embodiments;

FIG. 4 is another front view of the wireless communication terminal shown in FIG. 3 in which the relative size of the portion of the touch sensitive display that is used to display text, which is entered by the user typing on the combined displayed and keypad portion of the keyboard, is controlled in response to various defined conditions in accordance with some embodiments;

FIG. 5 is another front view of the wireless communication terminal shown in FIG. 3 in which the relative contrast and/or color between the displayed portion of the keyboard and the overlapping displayed text, which is entered by the user typing on the combined displayed and keypad portion of the keyboard is controlled in response to various defined conditions in accordance with some embodiments;

FIG. 6 is a block diagram of a wireless communications terminal includes a controller that controls a touch sensitive display to provide a combination of displayed and keypad portions of a keyboard in accordance with some embodiments of the present invention;

FIG. 7 is a flowchart of operations that may be carried out by the controller of FIG. 6 to control the display of a keypad on the touch sensitive display in accordance with some embodiments of the present invention; and

FIG. 8 is a flowchart of further operations that may be carried out by the controller of FIG. 6 to form a keyboard that extends across the touch sensitive display and the keypad in accordance with some embodiments of the present invention.

### DETAILED DESCRIPTION OF PREFERRED EMBODIMENTS

Various embodiments of the present invention will now be described more fully hereinafter with reference to the accompanying drawings. However, this invention should not be construed as limited to the embodiments set forth herein. Rather, these embodiments are provided so that this disclosure will be thorough and complete, and will convey the scope of the invention to those skilled in the art.

It will be understood that, as used herein, the term “comprising” or “comprises” is open-ended, and includes one or more stated elements, steps and/or functions without precluding one or more unstated elements, steps and/or functions. As used herein, the singular forms “a”, “an” and “the” are intended to include the plural forms as well, unless the context clearly indicates otherwise. The term “and/or” and “/” includes any and all combinations of one or more of the associated listed items. In the drawings, the size and relative sizes of regions may be exaggerated for clarity. Like numbers refer to like elements throughout.

Some embodiments may be embodied in hardware and/or in software (including firmware, resident software, micro-code, etc.). Consequently, as used herein, the term “signal” may take the form of a continuous waveform and/or discrete value(s), such as digital value(s) in a memory or register. Accordingly, as used herein, the terms “circuit” and “controller” may take the form of digital circuitry, such as computer-readable program code (e.g., software applications) executed by an instruction processing device(s) (e.g., general purpose microprocessor and/or digital signal processor), and/or analog circuitry.

Embodiments are described below with reference to block diagrams and operational flow charts. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

It will be understood that a block of the block diagrams or flowcharts, and combinations of blocks in the block diagrams or flowcharts, may be implemented at least in part by computer program instructions. These computer program instructions may be provided to one or more enterprise, application, personal, pervasive and/or embedded computer systems, such that the instructions, which execute via the computer system(s) create means, modules, devices or methods for implementing the functions/acts specified in the block diagram block or blocks. A computer program according to embodiments of the invention comprises a computer usable storage medium having computer-readable program code embodied therein. Combinations of general purpose computer systems and/or special purpose hardware also may be used in other embodiments.

These computer program instructions may also be stored in memory of the computer system(s) that can direct the computer system(s) to function in a particular manner, such that the instructions stored in the memory produce an article of manufacture including computer-readable program code which implements the functions/acts specified in block or blocks. The computer program instructions may also be loaded into the computer system(s) to cause a series of operational steps to be performed by the computer system(s) to produce a computer implemented process such that the instructions which execute on the processor provide steps for implementing the functions/acts specified in the block or blocks. Accordingly, a given block or blocks of the block diagrams and/or flowcharts provides support for methods, computer program products and/or systems (structural and/or means-plus-function).

Although various embodiments of the present invention are described in the context of wireless communication terminals for purposes of illustration and explanation only, the present invention is not limited thereto. It is to be understood that the present invention can be more broadly used in any sort of electronic device having a touch sensitive display and a separate keypad.

Various embodiments of the present invention may arise from the present realization that when an electronic device includes a touch sensitive display and a separate keypad, a keyboard can be created by combining a portion of the keyboard which is assigned to keys that are displayed on a touch sensitive display with another portion of the keyboard that is assigned to keys of the separate keypad. For example, part of a QWERTY keyboard can be assigned to keys that are displayed on the touch sensitive display and another part of the QWERTY keyboard can be assigned to keys on the keypad. Individual keys of the keypad can include multiple different indicia, such as numbers for use as a numeric keypad and letters for use as a QWERTY keyboard. Accordingly, a virtual keyboard can be created that extends across the touch sensitive display and the keypad, which may enable a user to more easily type sentences or other strings thereon.

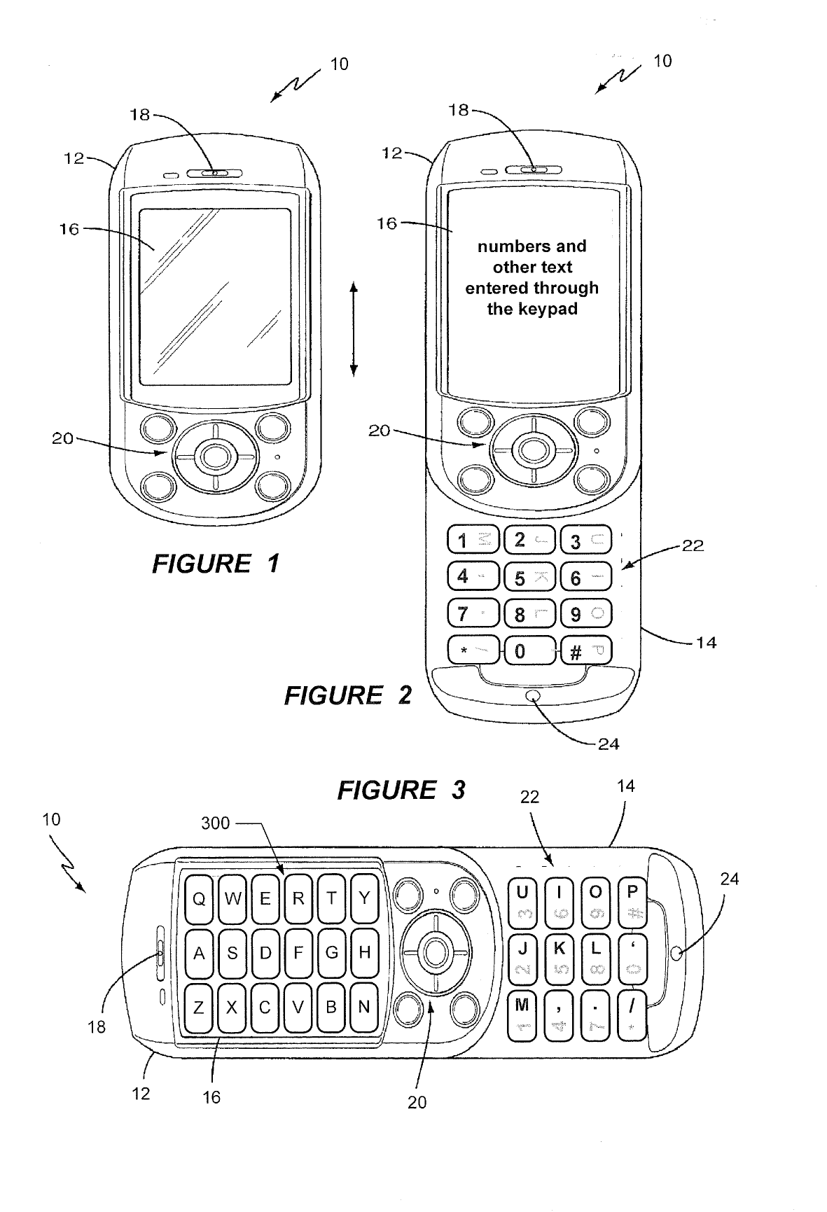

FIGS. 1 and 2 are front views of a wireless communication terminal 10 that is shown as being closed in FIG. 1 and being slid/rotated/flipped open in FIG. 2. The terminal 10 is configured to receive user input from one portion of a keyboard that is displayed on a touch sensitive display 16 and from another portion of the keyboard that is formed on a separate numeric keypad 22 in accordance with some embodiments. The touch sensitive display 16 is configured to display graphics and to detect user touches relative to the displayed graphics. The terminal 10 may further include a speaker 18, a microphone 24, and various user selectable interfaces 20 that are at least partially disposed within interconnected first and second housings 12 and 14.

Referring to FIG. 2, the keypad 22 can include keys having a first set of characters (e.g. numbers) arranged in a first orientation and having a second set of characters (e.g. alphabetic characters) arranged in a second orientation that is rotated about 90 degrees relative to the first orientation. In the illustrated embodiment, the keys labeled “1”, “2”, “3”, “4”, “5”, “6”, “7”, “8”, and “9” are also labeled at 90 degrees relative thereto with characters “M”, “J”, “U”, “,”, “K”, “I”, “.”, “L”, and “O”, respectively. Accordingly, when the terminal 10 is held upright as shown in FIG. 2 the numeric indicia on the keypad 22 are properly oriented for normal viewing by a user.

FIG. 3 is another front view of the terminal 10 shown in FIG. 2 which has been rotated onto its side. In contrast to FIG. 2, when the terminal 10 is held on its side as shown in FIG. 3 the alphabetic and other indicia on the keypad 22 are properly oriented for normal viewing by a user.

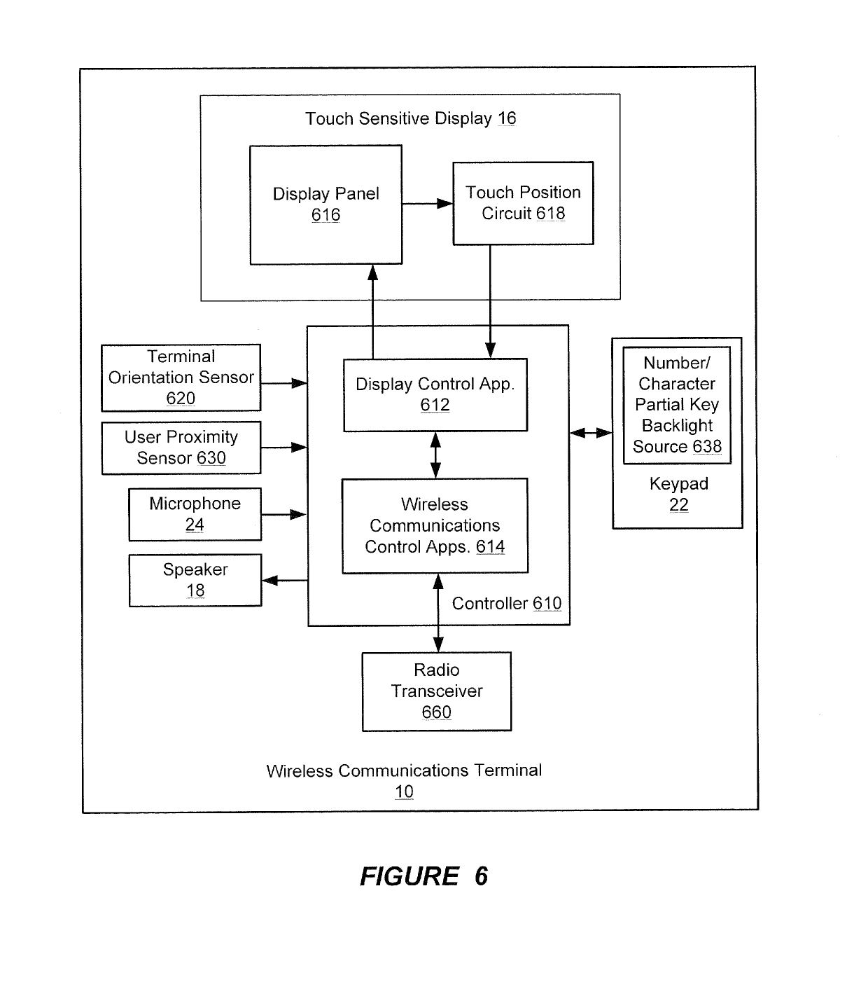

In accordance with some embodiments, the terminal 10 includes an orientation sensor 620 (FIG. 6) that detects rotation of the terminal 10 between first and second orientations that are rotationally offset from each other. The terminal 10 further includes a controller 610 (FIG. 6) that is configured to initiate display of a portion of a keyboard on the touch sensitive display 16 in response to the orientation sensor detecting that the terminal 10 resides in the first orientation (e.g., sideways), and to cease display of the portion of the keyboard on the touch sensitive display 16 in response to the orientation sensor detecting that the terminal resides in the second orientation (e.g., upright).

By way of example, when the terminal 10 is rotated from being upright (e.g., as shown in FIG. 2) to being on its side (e.g. as shown in FIG. 3), the controller 610 responds by displaying touch sensitive keys 300 for a portion of a QWERTY keyboard on the display 16. As shown in FIG. 3, the user is thereby presented with 18 keys of the QWERTY keyboard on the display 16, and another 12 keys of the QWERTY keyboard on the keypad 22. The user can thereby enter text into the terminal 10 by typing using a combination of the touch sensitive keys 300 shown on the display 16 and the keys of the keypad 22.

Alternatively or additionally, the controller 610 may initiate the display of QWERTY or other keyboard keys on the display 16 in response to detecting two or more time-overlapping touches on the display 16, and/or in response to detecting occurrence of other predefined triggering events (e.g., responsive to user manipulation of the interfaces 20 in a defined manner ).

In some embodiments, the terminal 10 can include backlighting (e.g. LEDs, electroluminescent elements, etc.) that is configured to illuminate the QWERTY indicia on the keys of keypad 22 while not significantly illuminating the other indicia (e.g. the numeric indicia) on the keys of keypad 22. The controller 610 can be configured to increase and/or turn-on the backlighting of the QWERTY indicia on the keys of keypad 22 in response to detecting that the terminal 10 resides in a first orientation (e.g., on its side as shown in FIG. 3), and to respond to the orientation sensor detecting that the terminal resides in a second orientation by decreasing and/or turning-off the backlighting of the QWERTY indicia on the keys of keypad 22. In some further embodiments, the QWERTY indicia and the numeric indicia on the keys of the keypad 22 may have separately controllable backlighting, and the controller 610 may control the backlighting that is provided to the QWERTY indicia relative to that provided to the numeric indicia on the keys of the keypad 22 to make one set of indicia more visible than the other set in response to the terminal 10 moving between first and second orientations.

Consequently, referring to FIG. 2, when the terminal 10 is held in the second orientation (e.g. held upright) the QWERTY indicia on the keys of keypad 22 are less visible than the numeric indicia on the keys of the keypad 22. In sharp contrast, referring to FIG. 3, when the terminal 10 is held in the first orientation (e.g. held sideways) the QWERTY indicia on the keys of keypad 22 are more visible than the numeric indicia on the keys of the keypad 22. Controlling the backlighting in this manner may make the QWERTY keyboard that is formed across the keypad 22 and the display 16 more readable when the terminal 10 is held in the second orientation (e.g. on its side).

The exemplary embodiments that are shown and described with regard to FIGS. 1-3 are provided for purposes of explanation of various embodiments, however it is to be understood that the present invention is not limited to such configurations, but is intended to encompass any configuration capable of carrying out at least one of the operational embodiments described herein.

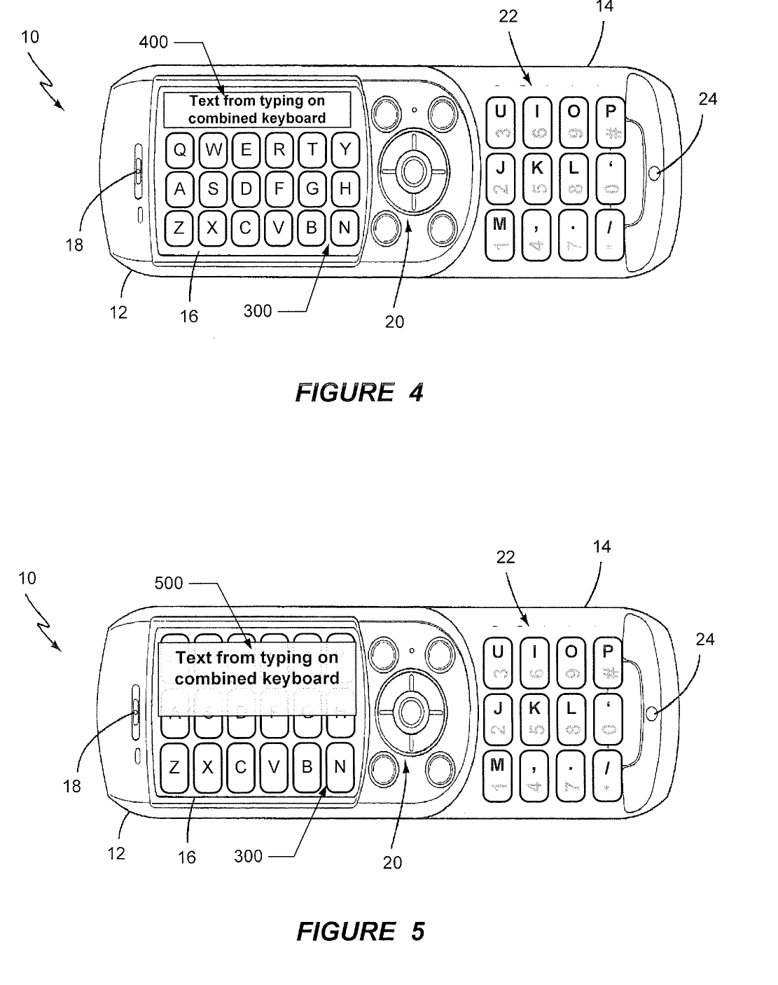

FIG. 4 is another front view of an embodiment of the terminal 10 in which the relative size of a portion 400 of the display 16 that is used to display text, which is entered by the user typing on the combined displayed keyboard 300 and the keypad 22, is controlled in response to various defined conditions.

Referring to FIG. 4, as a user types text onto the keyboard formed by the displayed keyboard keys 300 and the keypad 22, the controller 610 (FIG. 6) displays the entered text in the text area 400. In some embodiments, the controller 610 is configured to respond to a user's touch selection of one of the display keyboard keys 300 by decreasing the size (e.g., height and/or width) of the displayed text area 400 and/or increasing the size (e.g., height and/or width) of displayed keyboard keys 300, which may facilitate user selection of the displayed keyboard keys 300. The controller 610 may then respond to expiration of a threshold time since a last user touch selection of one of the display keyboard keys 300 by increasing the size of the displayed text area 400 and/or decreasing the size of displayed keyboard keys 300. Accordingly, the relative sizes of the displayed text area 400 and the displayed keyboard keys 300 may be dynamically controlled so as to make the keyboard keys 340 easier to select as the user types, and to make the text displayed in the text area 400 easier to read while the user pauses between typing.

In another embodiment, the terminal 10 may include a user proximity sensor 630 (FIG. 6), which may include a light source and a light detector, and be configured to respond to detection of at least a threshold amount of reflected light from the light source by generating a user proximity signal that indicates that a user manipulated object has become proximately located to the touch sensitive display. The controller 610 can be further configured to respond to the user proximity signal by increasing the size of the displayed keyboard keys 300 and decreasing the size of text area 400, and to respond to absence of the user proximity signal by decreasing the size of the displayed keyboard keys 300 and increasing the size of text area 400. Accordingly, the relative sizes of the text area 400 and the keyboard keys 300 may be dynamically controlled in response to sensing that a user's hand or other object has become proximately located to the display 16. Such control may make the keyboard keys 340 easier to select as the user types and make the text that is displayed in the text area 400 more easy to read while the user pauses between typing.

In another embodiment, the controller 610 is further configured to respond to detecting the sliding movement of an object that is touching within an area of the displayed keyboard keys 300 and moving outward therefrom by increasing the size of the displayed keyboard keys 300. The controller 610 may be similarly configured to respond to detecting the sliding movement by an object moving outward from the text area 400 by increasing the size of the text area 400. Accordingly, the user may change the size of the display keyboard keys 300 and/or the size of the text area 400 by sliding a finger or other object on the screen to expand or contract the respective display areas.

FIG. 5 is another front view of an embodiment of the terminal 10 in which the relative contrast and/or color between the displayed keyboard keys 300 and the displayed text 500, which is entered by the user through typing on the combined displayed keyboard keys 300 and keypad 22 portion of the keyboard, is controlled in response to occurrence of various defined conditions.

Referring to FIG. 5, as a user types text onto the displayed keyboard keys 300 and the keypad 22, the controller 610 (FIG. 6) displays the entered text in the text area 500. In some embodiments, the controller 610 is configured to display the text area 500 overlapping the displayed keyboard keys 300. The controller 610 can respond to the orientation sensor detecting movement of the terminal between the first and second orientations by controlling relative contrast between the keyboard keys 300 and the text that is displayed in the text area 500, such as by darkening one while fading-out the other.

In one embodiment, the controller 610 can respond to a user touch selection of one or more of the display keyboard keys 300 by increasing darkness of the displayed keyboard keys 300 relative to the text that is displayed in the text area 500. The controller 610 can then respond to expiration of a threshold time since a last user touch selection of one displayed keyboard keys 300 by decreasing darkness of the displayed keyboard keys 300 relative to the text that is displayed in the text area 500. Accordingly, the text 500 and the keyboard keys 300 can be displayed in an overlapping manner on the display 16. The readability of the keyboard keys 300 can be improved by increasing their darkness relative to the text 500 while a user is typing on the keyboard keys 300, and the readability of the text 500 can be improved by increasing its darkness relative to the keyboard keys 300 while the user pauses between typing.

In another embodiment, the controller 610 can respond to a user touch selection of one or more of the display keyboard keys 300 by changing the color of the displayed keyboard keys 300 and/or the color of the text that is displayed in the text area 500. The controller 610 can then respond to expiration of a threshold time since a last user touch selection of one of the displayed keyboard keys 300 by changing the color of the displayed keyboard keys 300 and/or the color of the text that is displayed in the text area 500. Accordingly, the readability of the overlapping text 500 and keyboard keys 300 can be improved by changing the keyboard keys 300 to a color that is more easily viewed while a user is typing on the keyboard keys 300, and the readability of the text 500 can be improved by changing its color to one that is more easily viewed while the user pauses between typing.

In another embodiment, the controller 610 can respond to the user proximity signal by increasing darkness of the displayed keyboard keys 300 relative to the text that is displayed in the text area 500. The controller 610 can then respond to absence of the user proximity signal (e.g., absence of an object proximately located to the display 16) and/or to expiration of a threshold time since a last user touch selection of one of the displayed keyboard keys 300 by decreasing darkness of the displayed keyboard keys 300 relative to the text that is displayed in the text area 500. Accordingly, the text 500 and the keyboard keys 300 can be displayed in an overlapping manner on the display 16, and the readability of the keyboard keys 300 can be improved by increasing their darkness relative to the text 500 in response to detecting that the user's hand and/or another object has become close to the display 16.

In another embodiment, the controller 610 can respond to the orientation sensor 620 (FIG. 6) detecting that the terminal 10 is held in a first defined orientation (e.g., sideways orientation of FIG. 5) by increasing darkness of the displayed keyboard keys 300 relative to the text that is displayed in the text area 500, and can respond to the orientation sensor detecting that the terminal is held in a second defined orientation (e.g. upward orientation of FIG. 2), which is rotationally offset from the first defined orientation, by decreasing darkness of the second group of keys relative to the sequence of alphabetic characters that are displayed on the touch sensitive display. Accordingly, the text 500 and the keyboard keys 300 can be displayed in an overlapping manner on the display 16, and the readability of the text 500 and the keyboard keys 300 can be maintained by alternately increasing the darkness of one relative to the other in response to orientation of the terminal 10.

In another embodiment, the controller 610 can respond to the orientation sensor 620 (FIG. 6) detecting that the terminal 10 is held in a first defined orientation (e.g., sideways orientation of FIG. 5) by changing the color of the displayed keyboard keys 300 to a defined color, and can respond to the orientation sensor detecting that the terminal is held in a second defined orientation (e.g. upward orientation of FIG. 2), which is rotationally offset from the first defined orientation, by changing the color the display keyboard keys 300 to a different defined color.

The exemplary embodiments that are shown and described with reference to FIGS. 4-5 are provided for purposes of explanation of various embodiments, however, it is to be understood that the present invention is not limited to such configurations, but is intended to encompass any configuration capable of carrying out at least one of the operational embodiments described herein.

FIG. 6 is a block diagram of exemplary circuitry that may be included in the wireless communication terminal 10 or within another type of electronic device. Referring to FIG. 6, the terminal 10 can include a controller 610, an orientation sensor 620, a user proximity sensor 630, a keypad 22, a touch sensitive display 16, a microphone 24, a speaker 18, and a radio transceiver 660.

The display 16 includes a display panel 616 and a touch position circuit 618. The display panel 616 and touch position circuit 618 may be configured as any type of touch sensitive display interface that generates electrical signals which indicate a relative position where the display panel 616 was touched with, for example, a finger and/or a stylus. For example, the display panel 616 and touch position circuit 618 may be configured as transparent/translucent touch sensor panel that extends across a display device (e.g., LCD or CRT display device).

The display 16 may be configured as a resistive touch display panel that includes two thin metallic or other electrically conductive and resistive layers separated by an insulated space. Touching one of the layers causes contact to the other layer at the contact position and causes voltage signals at the conductive contacts to have magnitudes which vary based on the effective resistance between the contact position and the respective conductive contacts. Accordingly, the relative magnitudes of the output voltages indicates the coordinate position where the display 16 is touched. The display 16 may additionally or alternatively be configured as a capacitance touch panel that is configured to generate a sinusoidal signal having characteristics that are modulated differently in response to different touched locations on the display 16. It is to be understood that the display 16 is not limited to these exemplary embodiments.

The orientation sensor 620 may be configured to detect a relative tilt angle of the terminal 10 relative to the horizon. The orientation sensor 620 may, for example, respond to movement of a weighted bearing across contact switches and/or may include one or more accelerometers.

The proximity sensor 630 may include a light source and a light detector, and may be configured to respond to detection of at least a threshold amount of light that is reflected to the light detector from the light source by generating a user proximity signal that indicates that a user manipulated object has become proximately located to the display 16.

The keypad 22 can include backlighting 638 (e.g. LEDs, electroluminescent elements, etc.) that is configured to illuminate the QWERTY or other indicia on the keys of keypad 22 while not significantly illuminating the other indicia (e.g. the numeric indicia) on the keys of keypad 22.

The radio transceiver 660 is configured to communicate over a wireless air interface with one or more RF transceiver base stations and/or other wireless communication terminals using one or more wireless communication protocols such as, for example, Global Standard for Mobile (GSM) communication, General Packet Radio Service (GPRS), enhanced data rates for GSM evolution (EDGE), Integrated Digital Enhancement Network (iDEN), code division multiple access (CDMA), wideband-CDMA, CDMA2000, Universal Mobile Telecommunications System (UMTS), WiMAX, HIPERMAN, wireless local area network (e.g., 802.11), and/or Bluetooth.

The controller 610 can be configured to execute one or more wireless communication control applications 614 that carry out wireless communications functionality, such as conventional cellular phone functionality including, but not limited to, voice/video telephone calls and/or data messaging such as text/picture/video messaging through the radio transceiver 660.

The exemplary embodiments that are shown and described with regard to FIG. 6 are provided for purposes of explanation of various embodiments, however it is to be understood that the present invention is not limited to such configurations, but is intended to encompass any configuration capable of carrying out at least one of the operational embodiments described herein.

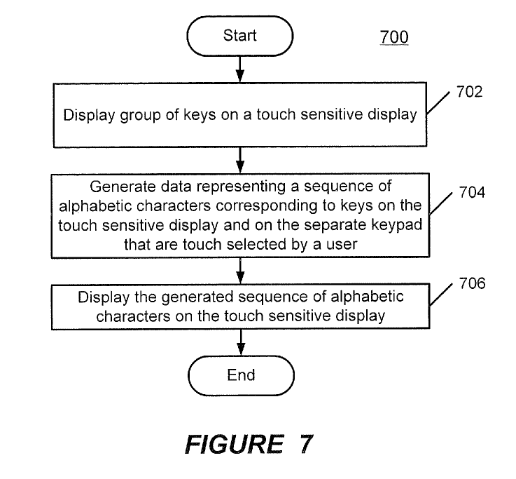

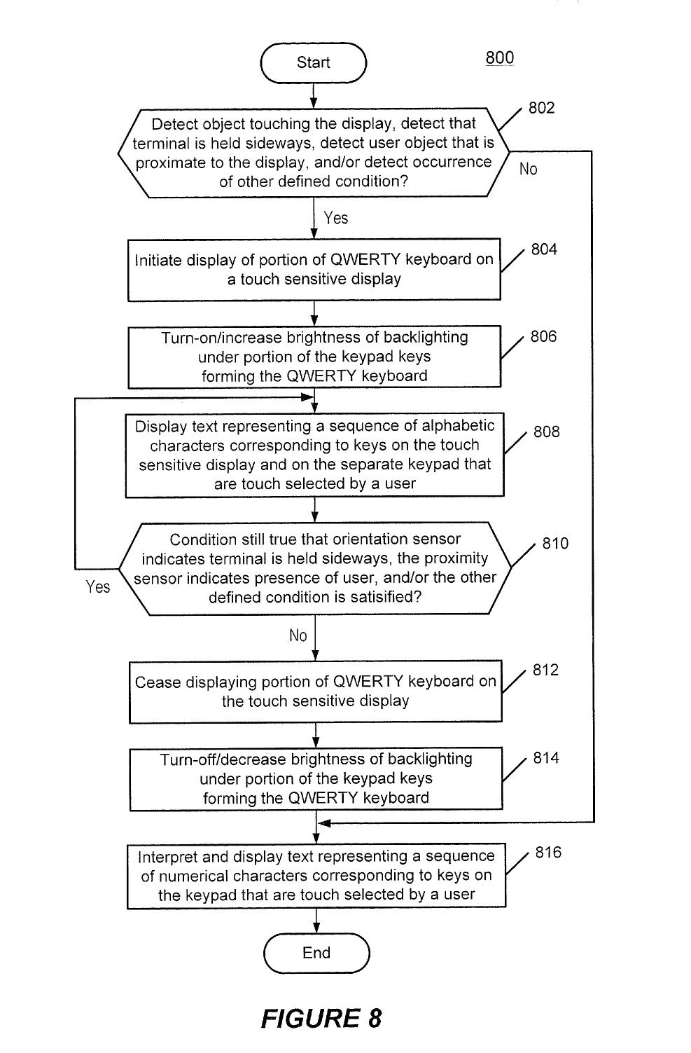

The controller 610 can be configured to execute a display control application 612 that controls the display of the keyboard keys 300 and text that has been typed on the keyboard keys 300 and keypad 22, and that controls backlighting of the keypad 22 in response to the various events described herein and which are further described below with regard to FIGS. 7 and 8.

FIG. 7 is a flowchart of fundamental operations 700 that may be carried out by the controller 610 (e.g. via the display control application 612) to control the display of a keyboard on the display 16 in accordance with some embodiments. Referring to FIG. 7, the controller 610 displays (block 702) a group of keys on the touch sensitive display 16. The controller 610 generates (block 704) data that represents the sequence of alphabetic or other characters corresponding to keys on the display keyboard and on the separate keypad that are touch selected by a user. The generated sequence of characters is displayed (block 706) on the display 16.

FIG. 8 is a flowchart of further operations 800 that may be carried out by the controller 610 (e.g. via the display control application 612) in response to various defined conditions. Referring to FIG. 8, the controller 610 can respond (block 802) to various defined conditions, including detecting that an object has touched the display 16, detecting that the signal from the orientation sensors 620 indicates that the terminal 12 is being held sideways or another defined orientation, and/or detecting that the signal from the proximity sensor 630 indicates that a user object has become proximately located to the display 16. The controller 610 may respond thereto by initiating display (block 804) of a portion of a keyboard (e.g. a portion of the QWERTY keyboard) on the display 16. The controller 610 may further respond thereto by turning-on/increasing brightness of backlighting by the backlight source 638 (block 806) under a portion of the keypad keys 22 that form another portion of the keyboard (e.g., another portion of the QWERTY keyboard).

The controller 610 displays (block 808) text representing a sequence of alphabetic or other characters corresponding to keys of the keyboard that have been touch selected by a user on the display 16 and on the keypad 22.

While one or more of the conditions that triggered display of the portion of the keyboard on the display 16 (block 802) are still occurring (block 810), the controller 610 can continue to display further sequences of alphabetic or other characters while a user types on the virtual keyboard extending across the display 16 and the keypad 22. When the triggering condition(s) are no longer occurring, the controller 610 can cease displaying (block 812) the portion of a keyboard (e.g. a portion of the QWERTY keyboard) on the display 16. The controller 610 may further respond thereto by turning-off/decreasing brightness of backlighting by the backlight source 638 (block 814) under the portion of the keypad keys 22 that form the other portion of the keyboard (e.g., another portion of the QWERTY keyboard).

While the controller 610 is not displaying the keyboard keys 300 on the display 16, it can interpret user selections of keys on the keypad 22 as having a different meaning than when the keyboard keys 300 are being displayed on the display 16. For example, with reference to FIG. 2, the controller 610 can interpret a user's touch selections on the keypad 22, while the keyboard keys 300 are not being displayed, as corresponding to one of the illustrated numbers 1-9 and characters “*” and “#” (block 816).

In the drawings and specification, there have been disclosed typical preferred embodiments of the invention and, although specific terms are employed, they are used in a generic and descriptive sense only and not for purposes of limitation, the scope of the invention being set forth in the following claims.

What is claimed is:

1. An electronic device comprising:
a keypad with a first group of keys that are assigned to a first portion of a keyboard;
a touch sensitive display that is configured to display graphics and to detect user touches relative to the displayed graphics, wherein the keypad is separate from the touch sensitive display; and
a controller that is configured to assign the first group of keys to a first portion of a keyboard, to display on the touch sensitive display a second group of keys that are assigned to a second portion of the keyboard, and to output a sequence of characters corresponding to keys on the touch sensitive display and on the keypad that are touch selected by the user.

2. The electronic device of claim 1, wherein:
the first group of keys are arranged in a grid along rows and columns; and
the controller is configured to display on the touch sensitive display the second group of keys arranged in a grid along rows and columns that are parallel to the corresponding rows and columns of the first group of keys.

3. The electronic device of claim 1, wherein:
the controller is further configured to map user touch inputs received from the first group of keys of the keypad to correspond to input from a first portion of a QWERTY keyboard, to display the second group of keys arranged as a second portion of the QWERTY keyboard on the touch sensitive display, and to map user touch inputs on the second group of keys to correspond to typing on the second portion of the QWERTY keyboard.

4. The electronic device of claim 3, further comprising:
an orientation sensor that is configured to detect rotation of the terminal between first and second orientations that are rotationally offset from each other,
wherein the controller is further configured to initiate display of the second portion of the QWERTY keyboard on the touch sensitive display in response to the orientation sensor detecting that the terminal is positioned in the first orientation, and to cease display of the second portion of the QWERTY keyboard on the touch sensitive display in response to the orientation sensor detecting that the terminal is positioned in the second orientation.

5. The electronic device of claim 4, wherein:
the controller is further configured to respond to the orientation sensor detecting that the terminal is positioned with a defined one of the sides facing primarily downward by initiating display of the second portion of the QWERTY keyboard on the touch sensitive display.

6. The electronic device of claim 4, wherein:
the controller is further configured to respond to the orientation sensor detecting that the terminal is positioned in the first orientation by outputting alphabetic characters in response to user touch selections on keys of the keypad, and to respond to the orientation sensor detecting that the terminal is positioned in the second orientation by outputting numbers in response to user touch selections on the same keys of the keypad.

7. The electronic device of claim 6, wherein:
the first group of keys of the keypad are configured to display a plurality of different alphabetic characters in a first orientation and a plurality of different numbers in a second orientation that is rotated about 90 degrees relative to the first orientation; and
the controller is further configured to respond to the orientation sensor detecting that the terminal is positioned in the first orientation by displaying the second portion of the QWERTY keyboard on the touch sensitive display with alphabetic characters on the displayed second keys having the same first orientation as the alphabetic characters displayed on the keypad, and to respond to the orientation sensor detecting that the terminal is positioned in the second orientation by ceasing display of the second portion of the QWERTY keyboard on the touch sensitive display and displaying on the touch sensitive display text that has the same second orientation as the numbers on the keypad.

8. The electronic device of claim 7, wherein:
the controller is further configured to respond to the orientation sensor detecting that the terminal is positioned in the first orientation by increasing and/or turning-on backlighting of an alphabetic portion of the first group of keys of the keypad while substantially not backlighting a numeric portion of the first group of keys, and to respond to the orientation sensor detecting that the terminal is positioned in the second orientation by decreasing and/or turning-off backlighting of the alphabetic portion of the first group of keys of the keypad.

9. The electronic device of claim 3, wherein:
the controller is further configured to initiate display of the second portion of the QWERTY keyboard on the touch sensitive display in response to detecting at least two time-overlapping touches that have occurred on the touch sensitive display.

10. The electronic device of claim 1, further comprising:
an orientation sensor that is configured to detect rotation of the terminal between first and second orientations that are rotationally offset from each other,
wherein the controller is further configured to change color of the second group of keys of the keyboard displayed on the touch sensitive display in response to the orientation sensor detecting movement of the terminal between the first and second orientations.

11. The electronic device of claim 1, further comprising:
an orientation sensor that is configured to detect rotation of the terminal between first and second orientations that are rotationally offset from each other,
wherein the controller is further configured to display on the touch sensitive display the sequence of characters corresponding to the second group of displayed keyboard keys and the first group of keypad keys that are touch selected by the user, to display the sequence of characters overlapping the displayed second group of displayed keyboard keys, and to respond to the orientation sensor detecting movement of the terminal between the first and second orientations by controlling relative contrast between the second group of keyboard keys and the sequence of characters that are displayed on the touch sensitive display.

12. The electronic device of claim 11, wherein:
the controller is further configured to respond to the orientation sensor detecting that the terminal is positioned in the first orientation by increasing displayed darkness of the second group of keyboard keys relative to the sequence of characters that are displayed on the touch sensitive display, and to respond to the orientation sensor detecting that the terminal is positioned in the second orientation by decreasing the displayed darkness of the second group of keyboard keys relative to the sequence of characters that are displayed on the touch sensitive display.

13. The electronic device of claim 1, further comprising:
an orientation sensor that is configured to detect rotation of the terminal between first and second orientations that are rotationally offset from each other,
wherein the controller is further configured to display on the touch sensitive display the sequence of characters corresponding to the second group of displayed keyboard keys and the first group of keypad keys that are touch selected by the user, to display the sequence of characters overlapping the second group of keys, and to respond to the orientation sensor detecting movement of the terminal between the first and second orientations by changing color of the second group of keyboard keys and the displayed sequence of characters.

14. The electronic device of claim 1, wherein the controller is further configured to display on the touch sensitive the sequence of characters corresponding to the second group of displayed keyboard keys and the first group of keypad keys that are touch selected by the user, to display the sequence of characters overlapping the second group of keys, to increase darkness of the second group of keyboard keys relative to the sequence of characters that are displayed on the touch sensitive display in response to a user touch selection of one of the displayed second group of keyboard keys, and to decrease of the second group of keyboard keys relative to the sequence of characters that are displayed on the touch sensitive display in response to expiration of a threshold time since a last user touch selection of one of the displayed second group of keyboard keys.

15. The electronic device of claim 1, further comprising:
a user proximity sensor, which includes a light source and a light detector, and that is configured to respond to the light detector detecting at least a threshold amount of reflected light from the light source by generate a user proximity signal that indicates that a user manipulated object has become proximately located to the touch sensitive display; and
the controller is further configured to display on the touch sensitive the sequence of characters corresponding to the second group of displayed keyboard keys and the first group of keypad keys that are touch selected by the user, to display the sequence of characters overlapping the second group of keys, to control darkness of the second group of keyboard keys relative to the sequence of characters that are displayed on the touch sensitive display in response to the user proximity signal.

16. The electronic device of claim 1, wherein the controller is further configured to display in a first portion of the touch sensitive display the sequence of characters corresponding to the second group of displayed keyboard keys and the first group of keypad keys that are touch selected by the user, to display the second group of keyboard keys in a second portion of the touch sensitive display that is adjacent to the first portion of the display, to increase the size of the second portion of the display that is used to display the second group of keyboard keys and to decrease the size of the first portion of the display in response to a user touch selection of one of the displayed second group of keyboard keys, and to decrease the size of the second portion of the display that is used to display the second group of keyboard keys and to increase the size of the first portion of the display in response to expiration of a threshold time since a last user touch selection of one of the displayed second group of keyboard keys.

17. The electronic device of claim 16, further comprising:
a user proximity sensor, which includes a light source and a light detector, and that is configured to respond to the light detector detecting at least a threshold amount of reflected light from the light source by generate a user proximity signal that indicates that a user manipulated object has become proximately located to the touch sensitive display; and
the controller is further configured to respond to the user proximity signal by increasing the size of the second portion of the display that is used to display the second group of keyboard keys and by decreasing the size of the first portion of the display, and to respond to absence of the user proximity signal during at least a threshold elapsed time by decreasing the size of the second portion of the display that is used to display the second group of keyboard keys and by increasing the size of the first portion of the display.

18. The electronic device of claim 16, wherein:
the controller is further configured to respond to detection of an object that is touching the second portion of the display and moving outward therefrom by increasing the size of the displayed second group of keyboard keys.

19. The electronic device of claim 1, wherein:
the keypad is configured so that ten of the first group of keys show ten different numbers in a first orientation and also show ten different alphabetic characters in a second orientation that is rotated about 90 degrees relative to the first orientation.

20. A method comprising:
electronically assigning a first group of keys of a keypad to a first portion of a keyboard;
displaying on a touch sensitive display a second group of keys that are assigned to a second portion of the keyboard;
electronically generating data representing a sequence of characters corresponding to keys on the touch sensitive display and on the keypad that are touch selected by the user; and
displaying the generated sequence of characters on the touch sensitive display.
